(19) United States
(12) Patent Application Publication
(10) Pub. No.: US 2006/0110698 A1
(43) Pub. Date: May 25, 2006

(54) Dental orthotic devices and methods for management of impaired oral functions and resultant indications

(76) Inventor: Farrand C. Robson, Tacoma, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/246,568

(22) Filed: Oct. 7, 2005

Related U.S. Application Data
(63) Continuation-in-part of application No. 10/962,004, filed on Oct. 8, 2004.
(60) Provisional application No. 60/617,472, filed on Oct. 8, 2004.

(51) Int. Cl. A61C 3/00

(52) U.S. Cl. 433/6

(57) ABSTRACT

A dental orthotic comprises a mandibular orthotic conforming to a user's mandibular dentition and including oral contours adapted for adjusting the user's tongue/tooth/mouth interaction, and may include extensions for positioning the user's tongue. The contours are designed and applied to specific locations on the orthotic and extensions of the orthotic to promote a desired tongue response for specific physiological symptoms. The contours change the shape of the mandibular orthotic as well as the dental shapes within the mouth, resulting in repositioning and/or reshaping of the tongue and tissue of the throat, thereby improving the oral functions as well as relieving neuromuscular responses and autonomic nervous system dysfunctions. The dental orthotic may include a maxillary orthotic that is fixed with respect to the mandibular orthotic.

### CROSS-REFERENCE TO RELATED APPLICATIONS

This application is a continuation-in-part of pending U.S. patent application Ser. No. 10/962,004, filed Oct. 8, 2004, and claims priority from the same as well as pending U.S. Provisional Patent Application No. 60/617,472, filed Oct. 8, 2004.

### BACKGROUND OF THE INVENTION

1. Field of the Invention

The present invention generally relates to apparatus and methods for preventing, reducing or eliminating impaired oral functions and indications caused thereby and/or resulting therefrom. In particular, the present invention relates to an oral appliance, such as a dental orthotic, and to methods of diagnosing, selecting and designing such orthotics to treat certain indications.

2. Description of the Related Art

Oral appliances are sometimes used to treat and relieve upper airway disorders causing impairment of the primary oral functions of swallowing, speaking, and breathing, as well as obstructive sleep apnea (OSA) and snoring. For example, the present inventor previously developed an orthotic designed to elevate the tongue vertically and move it forward to reduce or eliminate such symptoms, a design that is the subject of U.S. Pat. No. 5,752,822. Another particular orthotic, having top and bottom trays shaped to conform to a patient's dentition, has also been used to reduce such symptoms. That orthotic, which is the subject of U.S. Pat. No. 5,794,627, comprises an elastic band extending between the top and bottom trays, and functions by pulling the jaw forward.

Primary oral function impairment also results in physiological compensation, such as forward head posture and other musculoskeletal compensations. As a result of these compensatory reactions, a variety of indirect symptoms have also been associated with impaired oral functions. These indirect symptoms include muscular pain of the head and neck.

The present inventor's previous invention has been known to result in users correcting forward head posture and thus to reduce or eliminate some of these indirect symptoms, such as aches and other discomfort. No known oral orthotic, however, has been designed to manage symptoms beyond upper airway disorders or those symptoms known to be closely associated with upper airway disorders.

### BRIEF SUMMARY OF THE INVENTION

The present invention is directed toward various apparatus and methods for altering the position, configuration and freedom of movement of selected portions of the tongue and mouth to correct not only upper airway disorders, but also body compensations and indications previously not recognized as being caused by such compensations.

Embodiments of the present invention include a mandibular orthotic conforming to at least a portion of the user's mandibular dentition and having opposing first and second side portions. The side portions may be connected by an extension therebetween. An inward projection from at least one of the side portions may be incorporated for supporting the user's tongue thereon or for carrying selected orthotic contours, as described below.

A surface of one or both side portions of the mandibular orthotic includes one or more oral contours located, sized and/or shaped to selectively modify the user's tongue/tooth/mouth interaction to create specific physiological responses. In general, the tongue responds when it touches the teeth and tissues in the mouth, and responsive muscle contraction in the tongue affects the shape and positioning of the tongue in the mouth. In turn, the shape and position of the tongue affects the tissue in the throat. The orthotic in general, and the oral contours in particular, change the shape of the mouth, which changes the responsive muscle contractions in the tongue, resulting in a repositioning of the tongue and the tissue of the mouth and throat. This repositioning improves oral functions and relieves the body from its compensatory neuromuscular responses and the resultant autonomic nervous system dysfunctions. When the autonomic nervous system no longer needs to react to unnatural musculoskeletal and other physiological compensatory responses caused by incorrect tongue shape or positioning, it can dedicate more of its finite energy to fighting other symptoms or correcting other indications. Thus, as described in more detail below, specific orthotic contours can be sized, shaped and/or positioned on the orthotic to correct a wide variety of indications not previously associated with oral function.

The oral contours may take specific shapes such as protrusions, depressions, and grooves, or may have a more general shape, moving larger portions of the tongue in a desired direction. The oral contours may be positioned on the first side portion, the second side portion and/or the extensions.

The oral contours can be made and sized by selectively sizing and forming a unitary mandibular orthotic or by adding material, such as acrylic, to an existing mandibular orthotic to build it up at selected locations. In addition to building selected areas, it is also envisioned that the relative size of selected oral contours may be decreased with respect to the surrounding surfaces to correct certain indications.

There are presently known mandibular relationships that, if altered with specific oral contours, can provide therapeutic benefits and decreased need of body compensations by certain muscles.

The dental orthotic may also include a maxillary orthotic on an upper surface of the mandibular orthotic. The maxillary orthotic includes a first side portion which is positioned on a first side of an upper arrangement of teeth of the user's mouth and a second side portion which is positioned on a second side of the upper arrangement of teeth of the user's mouth. The maxillary orthotic can engage the most posterior two or three teeth of the upper arrangement of teeth.

The maxillary orthotic may be affixed to the mandibular orthotic via adhesive to achieve more extensive forward movement of the tongue and jaw in relation to the upper teeth and throat of the user. The first side portion and the second side portion of the maxillary orthotic may also include oral contours for adjusting the tongue/teeth/mouth interaction.

The present invention is also directed toward methods for assessing upper airway disorders, compensatory response, and resultant physiological symptoms, and for designing and fitting therapeutic dental orthotics, such as those described above. The diagnostic system aids in the process of custom fitting the user's dentition and optimizes the effectiveness of the dental orthotic for each user.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a top plan view of an oral appliance, particularly a mandibular orthotic, according to an embodiment of the present invention;

FIG. 2 is a perspective view of the oral appliance of FIG. 1, engaging a lower dentition of a user's mouth;

FIG. 3 is a bilateral cross-sectional view of the oral appliance and mouth of FIG. 2;

FIG. 4 is a top plan view of an oral appliance, particularly a mandibular orthotic connected to a maxillary orthotic, according to another embodiment of the present invention;

FIG. 5 is a perspective view of the oral appliance of FIG. 4, engaging the lower dentition of a user's mouth; and

FIG. 6 is a bilateral cross-sectional view of the oral appliance and mouth of FIG. 5.

### DETAILED DESCRIPTION OF THE INVENTION

Specific embodiments of the invention will be described with reference to the enclosed drawings. The present invention is general directed toward oral appliances for addressing specific physiological symptoms through distinct combinations of tongue/tooth/mouth interaction and/or jaw alignment. The specific details shown in the drawings are provided for explanatory purposes. An individual of ordinary skill in the art will appreciate, after reviewing this entire disclosure, that details could be modified or eliminated from the illustrated embodiments without deviating from the spirit of the invention.

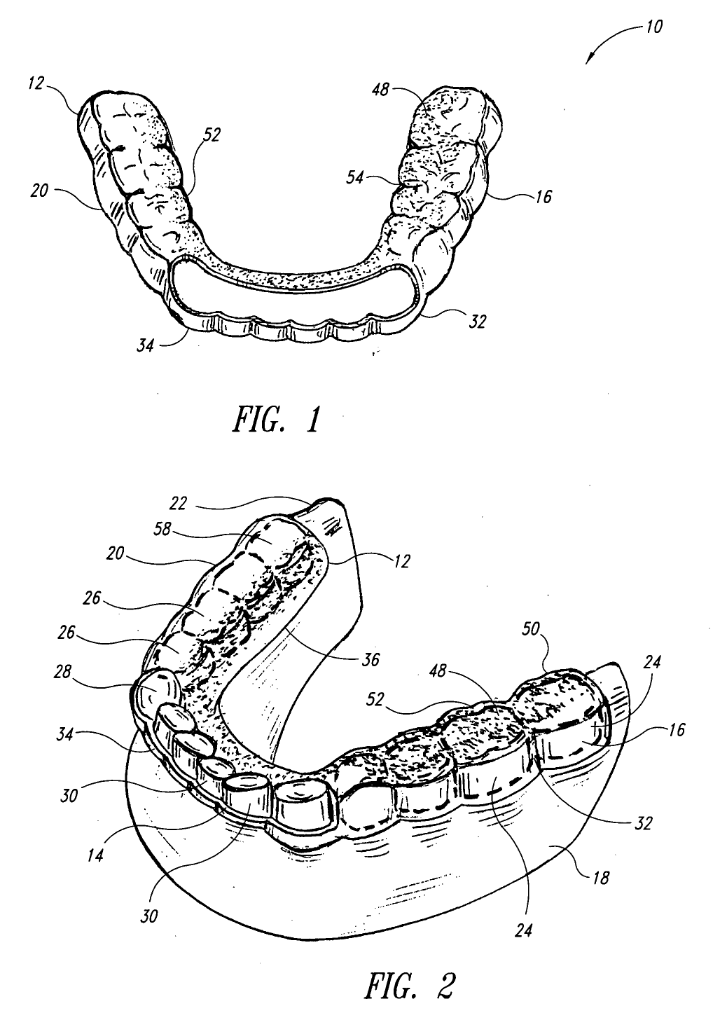

Referring to FIGS. 1 and 2, in a first embodiment a dental orthotic 10 comprises a mandibular orthotic 12 configured to engage a lower arrangement of teeth, or lower dentition 14, of a user's mouth. The illustrated mandibular orthotic 12 includes a first side portion 16 positioned to engage a first side 18 of the lower dentition 14 and a second side portion 20 positioned to engage a second side 22 of the lower dentition. The first side portion 16 and the second side portion 20 may be placed over molars 24, bicuspids 26, cuspids 28 and incisors 30 in the lower arrangement of teeth 14. It is understood, however, that the first and second side portions 16,20 are designed to conform to at least one tooth on each side of the user's lower arrangement of teeth.

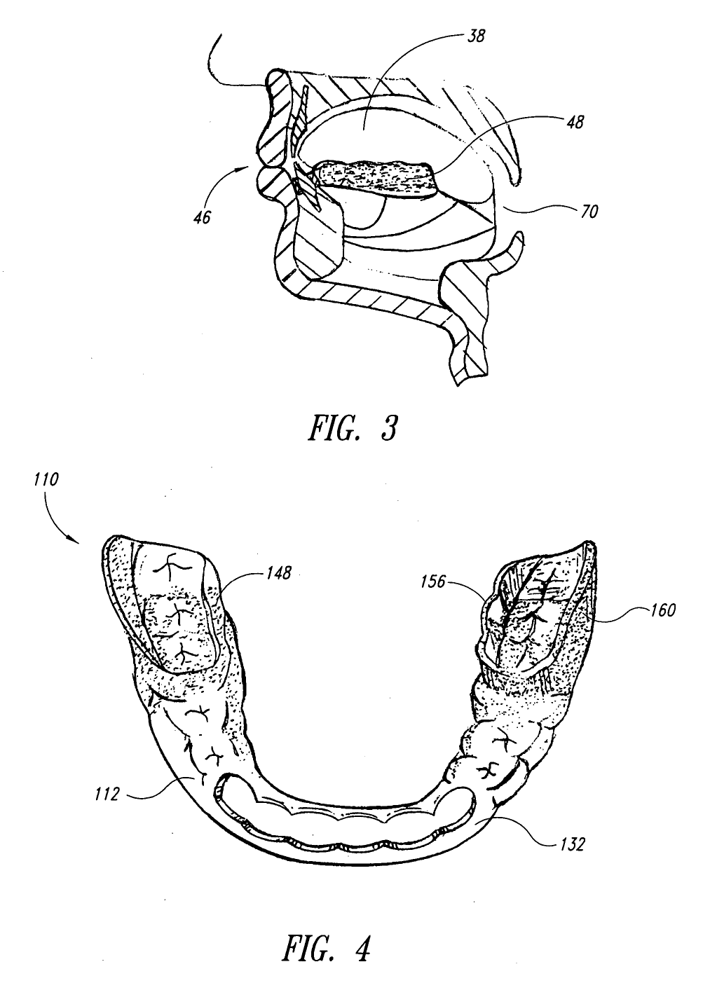

The mandibular orthotic 12 may be made of a pliable material, such as plastic or another suitable material. As shown in FIGS. 1 and 2, a wire 32 made of metal or other suitable material may be added to a front portion 34 between the first and second side portions 16,20. The wire 32 may provide strength and add to the longevity of use of the mandibular orthotic 12. The front portion 34 may also aid in raising a user's tongue 38, as illustrated in FIG. 3.

As shown in FIG. 2, the mandibular orthotic 12 may include extensions 36 for elevating a user's tongue 38 thereon. The illustrated extensions 36 are provided below the first and second side portions 16,20 near a lingual side of the mandibular orthotic 12, such that the extensions are next to and under the tongue 38 when the mandibular orthotic is being worn. The extensions 36 may be made of plastic or other suitable material, and may be molded as an addition to the mandibular orthotic 12 or otherwise affixed thereto.

An inner side of each extension 36 can have a convex shape at a central region, which, when positioned beneath the tongue, elevates and advances the tongue forward toward a front 46 of a user's mouth (FIG. 3). The extensions 36 may be designed to conform to the soft tissue on a floor of the user's mouth. It is understood that a depth of the extensions 36 may extend less or further down into the floor of the user's mouth than that illustrated, and is dependent upon the size and shape of the user's mouth. In addition, the extension 36 is sized and shaped such that the user does not experience impinging on tissue or other discomfort during use. It is also understood that at least one extension 36 is provided and extends from one of the first side portion 16 or the second side portion 20 of the mandibular orthotic 12.

The illustrated mandibular orthotic 12 includes a plurality of oral contours 48 that can be located, sized and shaped to address specific physiological symptoms in the user through distinct combinations of tongue, mouth and teeth interaction. The oral contours 48 may include specific shapes such as protrusions 50, depressions 52, and grooves 54. The oral contours 48 are positioned on an inner surface of the first side portion 16 and/or the second side portion 20 of the mandibular orthotic 12, and/or may be positioned on the extensions 36.

The shapes of teeth and tissues in the mouth that contact the tongue may cause muscle contraction in the tongue, thereby affecting the positioning of the tongue, teeth and tissue in the throat. The oral contours 48 are made, sized and shaped by selectively forming the mandibular orthotic 12 or by adding a material, such as acrylic, to the mandibular orthotic to build it up at desired locations. Similarly, in areas where there is excessive enlargement on the mandibular orthotic 12, the size of the contours 48 may be decreased. The oral contours 48 change the shape of the mandibular orthotic 12 as well as the shapes within the mouth, resulting in repositioning of the tongue and tissue of the throat, thereby improving the oral functions as well as relieving neuromuscular responses and autonomic nervous system dysfunctions.

There are presently specific mandibular relationships that, if altered by using the oral contours 48, may provide therapeutic benefits and decreased need of body compensations by certain muscles and parts of the autonomic nervous system. For example, listed below is the relationship between the region of the user's mouth and areas of the body where, in experimental cases, muscle contraction causing pain may occur due to impaired oral functions.

First molar=shoulder and temple areas,

Second Bicuspid=one-third down the upper half of the back from the shoulder to the mid back,

First Bicuspid and Cuspid=two-thirds down the upper half of the back from the shoulder to the mid back, and

Lateral and Central Incisors=the posterior mid back region at the level of the diaphragm.

Areas of muscle contraction symptoms may be controlled if adjacent muscle groups are well balanced through alteration of the dental orthotic 12. The following conditions, including enlarging or decreasing the thickness, shape and position of the oral contour 48 on the dental orthotic 12 are taken into consideration when the dental orthotic is being fitted and made:

(1) When the user's tongue is not free to move up out of the throat and into the mouth, muscle contractions may occur and lead to pain stimulated in specific locations of the head, neck, shoulder and/or upper back. Enlarging one or more oral contours 48 may move the tongue to the other side of the mouth and allow the tongue to move freely up from the throat and forward into the mouth.

(2) When the jaw of the user is positioned to one side, the user's tongue may not freely move to the opposite side of the mouth. Muscle contractions may occur and lead to pain stimulated in the head, neck, shoulder and upper back on the side on which the jaw is positioned. If the dental bite of the user contacts on one side, the jaw muscles on the opposite side may have increased muscle contraction too.

(3) When the tongue is prevented from moving over occlusal surfaces (i.e., the grinding surface) of the bicuspid teeth, there may be discomfort in the hip area of the opposite side. Hand pain may also occur under these circumstances.

(4) When the tongue does not freely pass over the first molar on a side of the mouth, there may be discomfort in the most inferior portion of the web of muscle between the thumb and first finger, and in the mid neck area on the opposite side of the body. There may also be hand pain such as thumb muscle tightness.

(5) When the tongue does not rest on the occlusal of the second bicuspid, thumb muscle tightness and/or pain may be present and superior to the region stimulated by the first molar. There may also be discomfort in the upper neck on the opposite side.

(6) When the tongue does not rest on the occlusal and lingual surfaces the first bicuspid and cuspid, there may be thumb muscle tightness and/or pain superior to the region stimulated by the second bicuspid. There may also be discomfort in the neck near the base of the skull on the opposite side.

(7) When the orthotic has excessive thickness in the region inferior to the molars and second bicuspid, discomfort in the anterior thigh and knee area may be present.

(8) When the dental orthotic is enlarged on the second molar and movement of the tongue is restricted, excessive lateral head tilt to the same side and diminished effectiveness of the teeth and structure anterior to the second molar may be present. An enlarged orthotic on the second molar may also result in elevation of the tongue to the soft palate. Nasal and sinus symptoms on the same side, gagginess and a reduction of the normal throat dimension in the hypopharynx may result as well. There may also be nerve like symptoms below the eye on the same side, pressure and pain in the lateral posterior skull on the opposite side and lateral posterior neck pain in the lower half of the neck on the opposite side.

(9) When the tongue is restricted from moving past the most posterior portion of the second molar, there may be same side discomfort in the upper back just below the crest of the shoulder and immediately lateral.

(10) When an oral contour 48 is enlarged near a mid molar area at the greatest height of the tooth near the occlusal surface of the tooth, reduction of muscle contraction pain at the top of the shoulder and immediately to the same side of the midline results. Temple and sub occipital discomfort also frequently relate to this region and resolves as the tongue is directed more anteriorly. Therefore, it is imperative that movement of the tongue anteriorly is not impaired by the mandibular anterior region.

(11) When oral contours 48 in the area anterior and inferior to the first molar is excessively thick, muscle tightness in the shoulder on the opposite side and difficulty with elevation of the shoulder may be present.

(12) When oral contours 48 have excessive thickness in the area below the bicuspids and cuspid, discomfort on the ulnar side of the hand and wrist may be present. The more posterior the oral area, the more superior the ulnar side forearm pain up to the elbow may exist.

(13) When oral contours 48 have excessive thickness in the region inferior to the molars and second bicuspid near the back teeth, discomfort to the anterior thigh and knee area may be present.

It is understood that oral contours 48 are molded as an addition to the mandibular orthotic 12 described above which is molded to fit selected teeth of the user. The oral contours 48 may include one contour or a plurality of contour shapes as long as the contours are provided in a manner that allows specific physiological symptoms to be addressed. The relationships between oral contours 48 and specific muscle groups is not limited to those discussed above. Furthermore, depending on the user's symptoms being treated, the mandibular orthotic 12 may be designed with only oral contours 48 and no extensions 36.

Referring to FIGS. 4 to 6, a second embodiment the dental orthotic 110 of the present invention may also include a maxillary orthotic 156, which is located on an upper portion of the mandibular orthotic 112 for engagement with at least some of the teeth of the upper dentition. The maxillary orthotic 156 includes a first side portion 160, which is positioned to mate with an outer surface of a corresponding first side of the upper dentition (not shown), and a second side portion 166, which is positioned to mate with an outer surface of a second side of the upper dentition. The illustrated first and second side portions 160,166 are positioned to extend over a biting surface of the teeth. The illustrated maxillary orthotic 156 engages the most posterior two or three teeth of the upper arrangement of teeth. Depending on the teeth present in the user's mouth, the teeth covered are typically a second bicuspid, a first molar and a second molar. It is understood, however, that the first side portion 160 and the second side portion 166 are designed to conform to at least one tooth on each side of the user's upper arrangement of teeth.

The maxillary orthotic 156 may be affixed to the mandibular orthotic 112 to achieve more extensive forward movement of the tongue and jaw in relation to the upper teeth and throat of the user. The mandibular orthotic 112 is generally placed forward relative to the position of the maxillary orthotic 156 in an advanced position which opens the airway 170 of the user and the user's bite vertically. The maxillary orthotic 156 also directs the user's tongue 138 into appropriate contact with the user's lower jaw. The maxillary orthotic 156 may be securely affixed to the mandibular orthotic using an adhesive substance that securely bonds two materials together by adhering to each other, such as an acrylic, or through other suitable means.

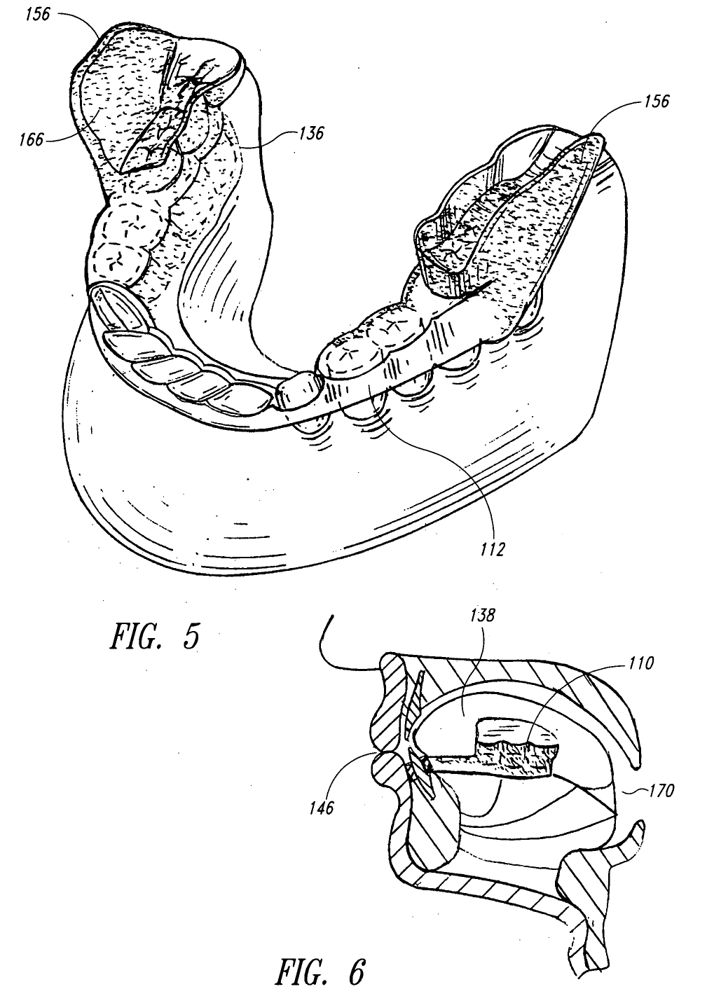

Similar to the mandibular orthotic, as shown in FIGS. 4 and 5, the maxillary orthotic 156 may include oral contours 148 on the first side portion 160 and the second side portion 166. The contours 148 located on the first side portion 160 and the second side portion 166 of the maxillary orthotic 156, and therefore near the upper jaw, may direct the tongue into an appropriate relationship with the lower arrangement of teeth and the lower jaw. For example, upper central incisors must not have excessive functional contact with the tongue near the midline, which is a plane through the very center of the user's mouth perpendicular to the nose. The lateral incisors must allow for passage of the tongue forward and downward. The first bicuspids' lingual surfaces are positioned more lingually than the second bicuspids and direct the tongue to the inferior in this region, as does the gingival portion of the cuspid. The second bicuspids are therefore more laterally positioned and allow for passage of the tongue. Oral contours 148 on the lingual surfaces of the first molars may also be used to direct the tongue downward.

The dental orthotic 12/112, with the addition of the extensions 36/136 and oral contours 48/148, may be polished so that the user does not experience any discomfort when wearing the orthotic device 10/110, such as impinging on the floor of the user's mouth or a lateral surface of the user's tongue. It is understood that the size and shape of the dental orthotic 10/110 may vary from user to user.

Diagnostic methods and systems for assessing upper airway disorders and physiological symptoms may be utilized in designing and fitting the dental orthotic 10/110. The diagnostic system aids in the process of custom fitting the user's dentition and optimizes the effectiveness of the dental orthotic for each user.

Evaluation of the user is performed by taking a highly specialized history of the user and the symptoms the user is experiencing at an initial office visit. Some users experience obvious impairments of jaw functions evidenced by their speech, swallowing, eating and breathing characteristics. In other individuals, however, these functions appear normal despite experiencing significant muscle and joint dysfunction. Therefore, the history is designed to reveal deficits in oral functions, especially apparently minor impairments in the jaw's contribution to breathing, swallowing and speaking.

Radiographs, Video Fluoroscope and Magnetic Resonance Imaging (MRI) may be used to provide valuable information about the oral function of a user before fitting and treatment with the dental orthotic. For example, imaging may reveal that a user's tongue blocks the throat and the epiglottis is obscured by a hyoid bone.

To assist in the evaluation of the dental orthotic 10/110 and determining if symptoms are relieved, temporary wax can be affixed to the dental orthotic 10/110 in the shape of the proposed extensions 36/136 and contours 48/148. The wax and dental orthotic 10/110 can then be covered with pressure indicating paste and the user encouraged to perform oral functions such as speaking, eating, swallowing, and breathing. After performance of the oral functions are completed, the dental orthotic 10/110 is removed and the pressure indicating paste assessed for areas that require removal or build up of contour. The adjustments are made to the dental orthotic 10/110 and the performance of oral functions is repeated until appropriate pressure is achieved on the desired areas corresponding to the specific characteristics of the symptoms being addressed.

Posture evaluations as well as heart rate variability and other systemic physiologic measures as well as specific electromyographic measures are often used to assess the effect of orthotic therapy.

Imaging may again be used to view anatomic relationships after treatment using the dental orthotic, 10/110 to determine whether the relationships have been partially or completely normalized. Once the final adjustments have been made to the dental orthotic 10/110 and the fitting of the user is completed, the temporary wax on the dental orthotic may be replaced by plastic or other suitable permanent materials.

The dental orthotic 10/110 of the present invention can be an effective treatment for not only upper airway disorders and specific neuromuscular responses, but also to autonomic nervous system symptoms. These symptoms include muscular pain of the head, face, neck, back, shoulder, hip, knee, elbow, hand and any muscular component associated with the forward head posture related to impaired oral functions, for example, many of the full body effects that have been associated with Temporomandibular Joint (TMJ) concerns. Additionally, autonomic nervous system symptoms such as elevated heart rate, fatigue, on-edge or stress-like feelings, cold or warm hands and feet, digestive symptoms, visual changes, fight or flight effects, disturbed sleep, sinus and nasal dysfunctions as well as many other symptoms may be associated with upper airway disorders. The inventive dental orthotic 10/110 moves the tongue and jaw forward which results in the muscles in the rest of body relaxing, thus relieving symptoms and other discomforts. The dental orthotic 10/110 also corrects the posture of the user. The dental orthotic 10/110 has high patient acceptance, increased comfort and treatment success for a long period of time.

Although the oral appliance is shown in FIGS. 1 to 6 with the dental orthotics 10/110 described above, it is understood and within the scope of the present invention that the features of the present invention may be used with any conventional oral appliance, such as orthotics that use retention hooks and elastic bands, as well as orthotics for day and night time use.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed:

1. An oral appliance for use in treating physiological imbalances of a user by altering the user's natural tongue, oral structure and tooth interaction, the oral appliance comprising:
an orthotic configured to conform to at least a portion of a user's dentition, the orthotic having an outer surface facing away from the dentition during use; and
a plurality of contours arranged on the outer surface of the orthotic, at least one of the plurality of contours being positioned at a selected location and being selectively sized and shaped to alter the user's tongue, oral structure and tooth interaction in a desired manner that reduces the physiological condition.

2. The oral appliance according to claim 1, wherein the at least one of the plurality of contours includes a depression.

3. The oral appliance according to claim 1, wherein the at least one of the plurality of contours includes a protrusion.

4. The oral appliance according to claim 1, wherein the at least one of the plurality of contours includes a groove.

5. The oral appliance according to claim 1, wherein the orthotic has a first side portion and a second side portion, the first side portion being configured to mate with a first side of the dentition and the second side portion being configured to mate with a second side of the dentition, and further comprising an extension projecting from each of the first side portion and the second side portion, the extensions being located on a lingual side of the orthotic such that the extensions project adjacent to and under the tongue during use.

6. The oral appliance according to claim 1 wherein the orthotic is configured for mating with a mandibular dentition, and further comprising a maxillary orthotic affixed to an upper surface of the orthotic.

7. The oral appliance according to claim 1, wherein the at least one of the plurality of oral contours includes an oral contour positioned on the orthotic to be near the user's bicuspid during use.

8. The oral appliance according to claim 1, wherein the at least one of the plurality of oral contours includes an oral contour positioned on the orthotic to be near the user's cuspid during use.

9. The oral appliance according to claim 1, wherein the at least one of the plurality of oral contours includes an oral contour positioned on the orthotic to be near the user's molar during use.

10. The oral appliance according to claim 1, wherein the at least one of the plurality of oral contours includes an oral contour positioned on the orthotic to be near the user's incisor during use.

11. The oral appliance according to claim 1, wherein the orthotic includes at least one oral contour enlarged to allow the user's tongue to move freely in the user's mouth.

12. The oral appliance according to claim 1, wherein the at least one oral contour is larger than both of the adjacent oral contours.

13. The oral appliance according to claim 1, wherein the at least one oral contour is smaller than both of the adjacent oral contours.

14. An oral appliance for addressing specific physiological symptoms through distinct combinations of jaw alignment, tongue and teeth interaction comprising:
an orthotic for advancing a jaw of a user forward, the orthotic conforming to the user's mandibular dentition and having a first side portion and a second side portion;
at least one extension for positioning the user's tongue so that the user's tongue rests on an upper surface of the extensions, the at least one extension extending from one of the first side portion and the second side portion; and,
a plurality of contours; wherein the plurality of contours are designed and applied to specific locations on the orthotic and extensions to promote a desired response for a specific physiological symptom.

15. A method for alleviating a desired physiological symptom of a user, the method comprising:
assessing the user's oral function; and
constructing an orthotic having at least one selected oral contour adapted to affect the position of at least a portion of the user's tongue within the user's mouth during use.

16. The method according to claim 15, wherein the selected oral contour is positioned to be located near the user's bicuspid during use, and wherein use of the orthotic alleviates a desired physiological condition associated with one or more of the following: neck, upper back, hip, thigh, knee, elbow, forearm, wrist, hand and thumb.

17. The method according to claim 15, wherein the selected oral contour is positioned to be located near the user's cuspid during use, and wherein use of the orthotic alleviates a desired physiological condition associated with one or more of the following: upper back, elbow, forearm, wrist, hand and thumb.

18. The method according to claim 15, wherein the selected oral contour is positioned to be located near the user's molar during use, and wherein use of the orthotic alleviates a desired physiological condition associated with one or more of the following: skull, temple, eye, nasal and sinus symptoms, gagginess, reduction of throat dimension, neck, upper back, shoulder, thigh, knee, thumb.

19. The method according to claim 15, wherein the selected oral contour is positioned to be located near the user's incisor during use, and wherein use of the orthotic alleviates a desired physiological condition associated with discomfort in a posterior mid back region at a level of a diaphragm.

20. The method according to claim 15, wherein the selected oral contour is positioned to allow the user's tongue to move freely during use, and wherein use of the orthotic relieves pain stimulated in a head, a neck, a shoulder and/or an upper back of a user.

21. The method according to claim 15, wherein the selected oral contour is positioned to relieve autonomic nervous system symptoms such as elevated heart rate, fatigue, on edge or stress like feelings, cold or warm hands and feet, digestive symptoms, visual changes, fight or flight effects, disturbed sleep, sinus and nasal dysfunctions.
